(19) United States
(12) Patent Application Publication
(10) Pub. No.: US 2008/0000226 A1
(43) Pub. Date: Jan. 3, 2008

(54) Method for operating an internal combustion engine having an exhaust gas turbocharger and a power turbine

(76) Inventors: Stefan Arndt, Uhingen (DE); Igor Gruden, Ditengen (DE); Christian Onnen, Aichwald (DE)

Correspondence Address: KLAUS J. BACH, 4407 TWIN OAKS DRIVE, MURRYSVILLE, PA, 15668, US

(21) Appl. No.: 11/821,547

(22) Filed: Jun. 22, 2007

Related U.S. Application Data
(63) Continuation-in-part of application No. PCT/EP05/13202, filed on Dec. 9, 2005.

(30) Foreign Application Priority Data
Dec. 24, 2004 (DE) 10 2004 062 492.5

(51) Int. Cl. F02B 29/04; F02B 33/44

(52) U.S. Cl. 60/599; 60/605.1

(57) ABSTRACT

In a method for operating an internal combustion engine having an exhaust gas turbocharger with an exhaust gas turbine in an exhaust tract, a power turbine arranged downstream of the exhaust gas turbine and an exhaust gas treatment unit arranged downstream of the power turbine, a pressure control device is provided in the exhaust tract downstream of the exhaust gas turbocharger and is moved toward a pressure release position so as to limit the exhaust gas pressure downstream of the exhaust gas turbine when the exhaust gas flow resistance in the exhaust gas treatment unit becomes excessive for example by a clogged particle filter.

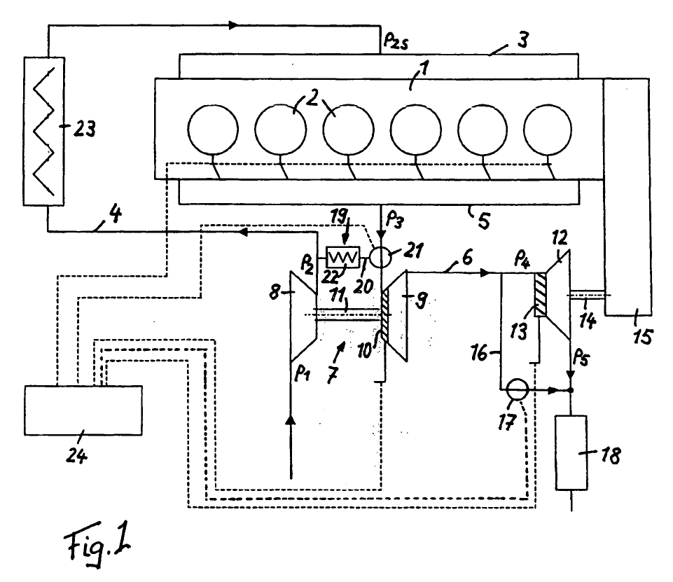

This is a Continuation-In-Part Application of pending International Patent application PCT/EP2005/013202 filed Dec. 9, 2005 and claiming the priority of German Patent Application 10 2004 062 492.5 filed Dec. 24, 2004.

### BACKGROUND OF THE INVENTION

The invention relates to a method of operating an internal combustion engine having an exhaust gas turbocharger and a power turbine arranged downstream of the exhaust gas turbocharger and being operatively connected to the internal combustion engine.

JP 08240156 A discloses a supercharged internal combustion engine which, in addition to the exhaust gas turbocharger, comprises a compound power turbine in the exhaust strand, which compound power turbine is coupled by means of a gearing to the crankshaft of the engine. The compound power turbine makes it possible to utilize the residual energy which the exhaust gas still has after passing through the exhaust gas turbine of the turbocharger and transmits said energy as drive torque to the crankshaft of the engine. The series-connection of the exhaust gas turbine and compound power turbine improves the overall efficiency of the internal combustion engine.

The internal combustion engine is equipped with an exhaust gas recirculation device comprising a recirculation line, which extends between the exhaust strand upstream of the exhaust gas turbine and the intake tract downstream of a charge air cooler which is arranged in the intake tract, and an adjustable blocking valve. During low load and low engine speed operation of the internal combustion engine, the blocking valve in the recirculation line can be opened, such that exhaust gas flows from the exhaust strand into the intake tract and is supplied to the cylinders of the internal combustion engine. A reduction in nitrogen oxide emissions can be achieved in this way.

In contrast, at high engine loads and high engine speeds, the blocking valve in the exhaust gas recirculation device is closed, such that all the exhaust gas flows firstly through the exhaust gas turbine and subsequently through the compound power turbine. In this way, the energy of the exhaust gas can be utilized in the most effective way possible.

At high engine loads but low engine speeds, the exhaust gas recirculation is advantageously likewise blocked and at the same time a bypass for bypassing the compound power turbine is opened, such that the pressure downstream of the exhaust gas turbine drops and a correspondingly high pressure gradient is generated across the exhaust gas turbine, which pressure gradient can be utilized for driving the turbocharger. In dynamic operating ranges, it is hereby possible to obtain a fast charge air pressure build-up.

In modern diesel internal combustion engines in particular, efficient exhaust gas purification is required including the filtering of soot particles in the exhaust gas flow. The soot particles are filtered out by means of a particle filter arranged in the exhaust strand. It is to be noted that, in such a particle filter, the pores of the filter in principle become blocked over the course of time, whereby the exhaust gas counterpressure rises and the turbine efficiency drops as a result of the reduced pressure gradient across the exhaust gas turbine. In order to eliminate the filtered-out soot particles, it is necessary for the particle filter to be burned free at regular intervals, for which purpose the air/fuel mixture which is supplied to the internal combustion engine is enriched, that is to say an undersupply of oxygen is provided in the internal combustion engine.

Based on this state of the art, it is the object of the present invention to improve the efficiency of an internal combustion engine which is equipped with an exhaust gas turbocharger, with a power turbine which is connected downstream of the turbocharger, and with an exhaust gas treatment unit.

### SUMMARY OF THE INVENTION

In a method for operating an internal combustion engine having an exhaust gas turbocharger with an exhaust gas turbine in an exhaust tract, a power turbine arranged downstream of the exhaust gas turbine and an exhaust gas treatment unit arranged downstream of the power turbine, a pressure control device is provided in the exhaust tract downstream of the exhaust gas turbocharger and is moved toward a pressure release position so as to limit the exhaust gas pressure downstream of the exhaust gas turbine when the exhaust gas flow resistance in the exhaust gas treatment unit becomes excessive for example by a clogged particle filter.

This reduces the exhaust gas counterpressure in the line section downstream of the exhaust gas turbine and increases the pressure gradient across the exhaust gas turbine, such that the exhaust gas turbine can deliver more power and the associated compressor in the intake tract can build up a higher charge pressure. The rising exhaust gas counterpressure in the line section between the exhaust gas turbine and the exhaust gas treatment unit as a result of the exhaust gas treatment unit becoming increasingly blocked can be compensated, at least partially, by opening the pressure control device, which is advantageous in particular if the pressure control device is initially in a partially closed or partially open position. The pressure control device is opened further as soon as a pressure rise, on account of the particle filter becoming increasingly blocked, can be detected downstream of the exhaust gas turbine. In this way a desired pressure gradient across the exhaust gas turbine can be maintained despite the filter becoming blocked.

In the internal combustion engine according to the invention, which is suitable for carrying out the method, actuating signals are generated in a closed-loop and open-loop control unit as a function of the exhaust gas counterpressure upstream of the exhaust gas treatment unit. The actuating signals are used for adjusting the pressure control device which is assigned to the power turbine. The actuating signals cause the pressure control device to be opened, such that at least a partial exhaust gas flow is conducted either into a bypass line for bypassing the power turbine, or an adjustable variable power turbine geometry, which is arranged in the turbine inlet cross section of the power turbine, is moved toward its open position. In both cases, the exhaust gas counterpressure downstream of the exhaust gas turbine is reduced, and the pressure ratio across the exhaust gas turbine is increased.

The pressure control device comprises a bypass line past the power turbine or a variable power turbine geometry for variably adjusting the effective turbine inlet cross section of the power turbine. It is possible with both embodiments to carry out pressure control. The two embodiments can also be combined with one another.

The exhaust gas turbine, which is part of the exhaust gas turbocharger of the internal combustion engine, is expediently also equipped with a variable turbine geometry, thereby providing an additional degree of freedom for controlling the pressure differential across the exhaust gas turbine. The variable turbine geometry of the exhaust gas turbine can be adjusted between a blocking position, which minimizes the effective turbine inlet flow cross section, and a maximum opening position, with the maximum opening position being set in particular at high load and high engine speed, whereas the blocking position is preferable used in the lower engine load and speed range. In the blocking position, the exhaust gas counterpressure upstream of the exhaust gas turbine is increased, such that high inlet flow speeds can be obtained through the remaining open flow passages in the variable turbine geometry, and the exhaust gas impinges on the turbine wheel at high speed. In this way, a rapid pressure build-up can be obtained even at low engine loads and speeds.

Furthermore, it is also possible to adjust in the engine braking mode both the variable turbine geometry of the exhaust gas turbine and the variable power turbine geometry. In this way, the exhaust gas counterpressure upstream of the exhaust gas turbine is increased by correspondingly adjusting the variable geometries, such that the pistons in the cylinders must perform exhaust work against the increased exhaust gas counterpressure.

The invention will become more readily apparent from the following description of a particular embodiment thereof described below with reference to the accompanying drawings.

### BRIEF DESCRIPTION OF THE DRAWINGS

The sole FIGURE is a schematic illustration of an internal combustion engine having an exhaust gas turbocharger and a compound exhaust gas power turbine.

### DESCRIPTION OF A PARTICULAR EMBODIMENT

The internal combustion engine 1 which is illustrated in the FIGURE is in particular a diesel internal combustion engine, or, if appropriate, it may also be a spark-ignition engine in the form of an in-line six-cylinder engine whose cylinders 2 are supplied with combustion air by means of a common air intake manifold 3. The exhaust gas of the cylinders 2 is discharged into a common exhaust gas manifold 5 which is part of the exhaust strand 6 and opens out into an exhaust duct of the exhaust strand. The air intake manifold 3 is part of the intake tract 4 and is supplied with combustion air by means of an air intake tract.

The internal combustion engine 1 is provided with an exhaust gas turbocharger 7 which comprises a compressor 8 in the intake tract 4 and an exhaust gas turbine 9 in the exhaust strand 6. The exhaust gas turbine 9 is equipped with a variable turbine geometry 10 for variably adjusting the effective turbine inlet flow cross section and by means of which the turbine inlet flow cross section can be adjusted between a minimum flow blocking position and a maximum flow opening position. The variable turbine geometry 10 is for example embodied as an axially adjustable guide vane structure or as a fixed guide vane structure with adjustable guide vanes. The rotational movement of the turbine wheel in the exhaust gas turbine 9 is transmitted by means of a shaft 11 to the compressor wheel disposed in the compressor 8.

Arranged downstream of the exhaust gas turbine 9 in the exhaust strand 6 is a compound power turbine 12 through which the exhaust gas is conducted for driving the turbine. The compound power turbine 12 is connected by means of its shaft 14 and a gearing 15 to the crankshaft of the engine, such that the drive or braking torque which is generated in the compound power turbine 12 is transmitted to the crankshaft of the engine. The power turbine 12 is, like the exhaust gas turbine, equipped with a variable power turbine geometry 13, by means of which the effective turbine inlet cross section in the power turbine 12 can be adjusted between a minimum flow blocking position and a maximum flow opening position. The variable power turbine geometry 13 can also be embodied for example as an axially adjustable guide vane structure or as a fixed guide vane structure with adjustable guide vanes.

The power turbine 12 includes a bypass 16 with a valve 17 arranged therein. The bypass 16 bypasses the power turbine 12, such that when the valve 17 is open, the entire exhaust gas or at least most of the exhaust gas is conducted via the bypass 16 so as to bypass the power turbine 12.

Arranged downstream of the power turbine 12 in the exhaust strand 6 is an exhaust gas aftertreatment unit 18 which comprises in particular a soot particle filter. Furthermore, the exhaust gas treatment unit 18 can also include further purification devices such as for example a catalytic converter.

On the air side, combustion air at the pressure p₁ is sucked in by the compressor and is compressed to the increased pressure p₂, at which the combustion air is supplied to a charge air cooler 23 which is arranged downstream of the compressor 8. After being cooled in the charge air cooler 23, the compressed combustion air at the charge pressure p₂ₛ flows into the air inlet manifold 3 and from there into the cylinders 2 of the internal combustion engine 1.

The exhaust gases discharged from the cylinders 2 are conducted via the exhaust gas manifold 5 into the adjoining exhaust line of the exhaust strand 6, and flow through the exhaust line section between the cylinder outlet and the exhaust gas turbine 9 at the exhaust gas pressure p₃. At the exhaust gas pressure p₃, the exhaust gases are supplied to the exhaust gas turbine 9 and are expanded in the exhaust gas turbine 9 to the exhaust gas pressure p₄, at which the exhaust gases are conducted to the inlet of the compound power turbine 12. Downstream of the compound power turbine 12, the exhaust gases are at the exhaust gas pressure p₅, at which the exhaust gases are supplied to the exhaust gas treatment unit 18.

The internal combustion engine 1 is additionally provided with an exhaust gas recirculation device 19 which comprises a recirculation line 20 with a closed-loop-controllable valve 21 arranged therein and an exhaust gas cooler 22. The recirculation line 20 branches off from the exhaust line section upstream of the exhaust gas turbine 9 and opens out into the intake tract 4 between the compressor 8 and the charge air cooler 23.

The internal combustion engine 1 includes a control unit 24 in which control signals are generated for adjusting and regulating the internal combustion engine 1 and the assemblies which are assigned to the internal combustion engine. The control signals are generated as a function of state and operating variables which characterize the operating state of the internal combustion engine or of the assemblies. Components which are adjusted include inter alia the valves at the cylinders 2, the control valve 21 in the exhaust gas recirculation device 19, the variable turbine geometry 10 in the exhaust gas turbine 9, the blocking valve 17 in the bypass 16 which bypasses the power turbine 12, and the variable power turbine geometry 13 in the power turbine 12.

On the exhaust gas side, there are four adjustment possibilities for regulating the exhaust gas counterpressure, specifically the control valve 21 in the exhaust gas recirculation device 19, the variable turbine geometry 10, the variable power turbine geometry 13 and the blocking valve 17 in the bypass 16. It is possible in particular by adjusting the variable power turbine geometry 13 and the blocking valve 17 in the bypass 16 to at least partially compensate for a rising exhaust gas pressure p₄ or p₅ downstream of the exhaust gas turbine 9, and an associated reduction in the pressure gradient across the exhaust gas turbine, which result from a particle filter becoming increasingly blocked. Once the particle filter in the exhaust gas aftertreatment unit 18 becomes blocked, firstly the exhaust gas pressure p₅ in the line section between the power turbine 12 and the exhaust gas aftertreatment unit 18 rises, as a result of which the pressure gradient p₄/p₅ across the power turbine 12 is reduced. With decreasing pressure gradient, however, the power generation capability of the power turbine 12 is reduced.

In order to compensate for an overall rising exhaust gas counterpressure p₄ or p₅ downstream of the exhaust gas turbine 9 as a result of a particle filter in the exhaust gas aftertreatment unit becoming increasingly blocked, the pressure control device which is assigned to the power turbine 12—that is to say the variable power turbine geometry 13 and/or the bypass 16 with the actuating valve 17—can be adjusted from a closed position or a partially open position in the to a further open position. As a result, the exhaust gas pressure p₄ in the line section between the exhaust gas turbine 9 and the power turbine 12 decreases and approaches the exhaust gas pressure p₅ in the line section directly upstream of the exhaust gas treatment unit 18. This pressure reduction in the line section directly downstream of the exhaust gas turbine 9, which pressure reduction is associated with a deactivation of the power turbine 12, increases the pressure gradient p₃/p₄ across the exhaust gas turbine 9, as a result of which the power generation capability of the exhaust gas turbine 9 is increased. With this approach, it is possible to compensate the power consumption in the exhaust gas turbine 9, despite a particle filter in the exhaust gas aftertreatment unit becoming blocked, until the soot particles which have accumulated in the particle filter are burned off, and the flow resistance in the particle filter is hereby reduced.

The reduction of the exhaust gas pressure p₄ downstream of the exhaust gas turbine 9 can also be utilized to improve the dynamic operation of the internal combustion engine in the fired drive operating mode. In particular in acceleration states at low engine speeds, in which only a low exhaust gas counterpressure p₃ prevails between the cylinder outlets and the turbine inlet, it is possible, by lowering the exhaust gas pressure p₄ downstream of the turbine, to increase the pressure drop across the turbine and to thereby provide rapidly for power generation of the turbine 9 and a fast charge air pressure build-up.

The embodiment with the power turbine which includes a pressure regulating device also offers advantages in operation with exhaust gas recirculation. It is possible to generate an exhaust-gas-recirculation-promoting high exhaust gas counterpressure p₃ upstream of the exhaust gas turbine 9 with a simultaneously high pressure drop across the exhaust gas turbine despite a particle filter in the exhaust gas aftertreatment unit 18 becoming increasingly blocked.

It is also possible to obtain an improvement of the operating behavior in the engine braking mode. Representative of the level of the engine braking power are the pressure conditions at the cylinder inlet and at the cylinder outlet of the internal combustion engine. A high charge air pressure generates a correspondingly high pressure level in the cylinders, with it being necessary for the pistons in the cylinders to exert exhaust work counter to the high exhaust gas counterpressure. The high exhaust gas counterpressure is obtained by means of an adjustment of the variable turbine geometry 10 in the direction of the blocking position; the exhaust gas at the same time flows through the remaining open flow passage areas of the variable turbine geometry 10 to the turbine wheel and imparts a driving impetus to the turbine wheel, as a result of which the turbocharger is brought up to, or held at, a relatively high rotational speed and can generate a high charge air pressure at the compressor side. The pressure drop, which is necessary for the turbocharger power across the exhaust gas turbine, is generated by means of the pressure control device of the power turbine 12, that is to say by adjusting the variable power turbine geometry 13 and/or the blocking valve 17 in the bypass line 16.

What is claimed is:

1. A method for operating an internal combustion engine with an intake tract (4) and an exhaust strand (6) including an exhaust gas turbocharger with a compressor (8) in the intake tract (4) and an exhaust gas turbine (9) in the exhaust strand (6), and also a power turbine (12) arranged in the exhaust strand (6) downstream of the exhaust gas turbine (9) and driven by the exhaust gases of the internal combustion engine (1), with pressure control devices (13, 17) arranged in the exhaust strand for controlling the exhaust gas counterpressure (p₄) between the exhaust gas turbine (9) and the power turbine (12), and further an exhaust gas treatment unit (18) arranged in the exhaust strand (6) downstream of the power turbine (12), said method comprising the steps of: adjusting, in the case of a rising exhaust gas pressure (p₄, p₅) in the exhaust strand (6) section downstream of the exhaust gas turbine (9) as a result of a blocked exhaust gas aftertreatment unit (18), the pressure control devices (13, 17) toward an open position so as to reduce the exhaust gas back pressure downstream of the exhaust gas turbine (9).

2. The method as claimed in claim 1, wherein, in an engine braking mode, the pressure control devices (13, 17) are adjusted in such a way as to provide for a demanded engine braking torque.

3. The method as claimed in claim 1, wherein, in the fired drive operating mode, the pressure control device (13, 17) are operated so as to provide for exhaust gas recirculation from the exhaust strand (6) to the intake tract (4).

4. The method as claimed in claim 1, wherein a variable turbine geometry (10) in the exhaust gas turbine (9) is controlled so as to provide a certain exhaust gas counter pressure (p₃).

5. An internal combustion engine including an exhaust gas turbocharger (7) which comprises a compressor (8) arranged in an intake tract (4) and an exhaust gas turbine (9) arranged in exhaust strand (6) of the internal combustion engine, a power turbine (12) arranged in the exhaust strand (6) downstream of the exhaust gas turbine (9) and being driven by the exhaust gases of the internal combustion engine (1), a pressure control device (13, 17) for controlling the exhaust gas pressure (p₄) between the exhaust gas turbine (9) and the power turbine (12), and an exhaust gas treatment unit (18) arranged in the exhaust strand (6) downstream of the power turbine (12), and also a control unit (24) for generating actuating signals for adjusting the pressure control devices (13, 17) as a function of the exhaust gas pressure (p₄, p₅) upstream of the exhaust gas treatment unit (18).

6. The internal combustion engine as claimed in claim 5, wherein the exhaust gas treatment unit (18) comprises a particle filter.

7. The internal combustion engine as claimed in claim 5, wherein the pressure control device comprises a bypass (16) which bypasses the power turbine (12) and includes a control valve (17).

8. The internal combustion engine as claimed in claim 5, wherein the pressure control devices comprise a variable power turbine geometry (13) for variably adjusting the effective turbine inlet cross section in the power turbine (12).

9. The internal combustion engine as claimed in claim 5, wherein the exhaust gas turbine (9) comprises a variable turbine geometry (10) for variably adjusting the effective turbine inlet flow cross section.

10. The internal combustion engine as claimed in claim 5, wherein an exhaust gas recirculation device (19) is provided, including a recirculation line (20) between the exhaust strand (6) and the intake tract (4) of the internal combustion engine (1) with an adjustable control valve (21) arranged in the recirculation line (20).
